(19) United States
(12) Patent Application Publication
(10) Pub. No.: US 2005/0213434 A1
(43) Pub. Date: Sep. 29, 2005

(54) Device for fastening a bracelet to a watch

(76) Inventor: Andreas Epstein, Munich (DE)

Correspondence Address: ANTHONY H. HANDAL;KIRKPATRICK & LOCKHART NICHOLSON GRAHAM LLP, 599 LEXINGTON AVENUE, 33RD FLOOR, NEW YORK, NY, 10022-6030, US

(21) Appl. No.: 10/523,091

(22) PCT Filed: Jul. 14, 2003
(86) PCT No.: PCT/IB03/03238

§ 371 Date: Feb. 1, 2005

(30) Foreign Application Priority Data
Aug. 2, 2002 (EP) 02017407.4

(51) Int. Cl. G04B 37/00

(52) U.S. Cl. 368/282

(57) ABSTRACT

The invention relates to a watch comprising a housing (1), at least one fastening member (7) such as a bracelet, and a device for joining the housing to the fastening member. Said housing (1) is provided with a first rim (8) on the lower circumference thereof, which is inserted into a groove (13) of a support (2) that is or is not connected to the fastening member (7) in order to fix the housing to a base (14) of the support (2). A flexible element (5) and a second rim (9) can be fixed to the upper circumference of the housing (1) such that the watch is reversible. The supports (2a, 2b) of the housing are provided with an exterior part (12) for inserting rings (6a, 6b) of the bracelet (7) and a lower part (11) on which the housing (1) rests. The flexible element (5) is made of a plastic or metal thread, the ends of which are fixed in at least one guiding member (2a, 2b) that is inserted into the fastening member (7). The inventive watch comprises at least one flexible element (5) forming an entire loop or two flexible elements (5) that are connected to at least one guiding member (2a, 2b) so as to form an entire loop.

The present invention relates to watch-making, more particularly to devices for attaching a bracelet to a watch.

A watch bracelet is a piece of jewelry that generally encircles the wrist. There are several types, such as extendable bracelets, bracelets with a cover, or marquise bracelets, made up for example of two parts joined by a clasp.

The two ends of the bracelet are attached via rings or other means to pins, hinges or loops on the watch casing.

So that a watch can be put on a wearer's wrist, it is known practice to use strong bracelets that must be securely fastened to the watch casing without neglecting their decorative aspect.

There are in particular two ways of fastening the bracelet to the watch casing, namely:
by welding, which implies that, in principle, the bracelet be made of the same material as the casing;
using small bars, the bracelet thus being removable, unlike in the above case.

It is known practice to attach a bracelet to a watch by means of an assembly, in which the watch is housed in a housing for fastening the watch, as shown in publication WO 88/06307. This device has the disadvantage of using expensive attachment elements.

The aim of the present invention is to propose a device for flexibly attaching a bracelet to a watch, in particular without the use of small bars.

This aim is achieved with a watch comprising a casing, at least one attachment such as a bracelet and a device linking the casing-attachment assembly, characterized in that the attachment is linked to the casing by means of at least one long flexible element designed to hold the attachment against the casing, the long flexible element delimiting in particular a space in which the casing may be inserted and held in place by contact of the flexible element on its circumference.

The attachment usually consists of a bracelet whose two ends are fastened to the opposite parts of the casing, or may consist of a body, for example a clip, that bears against the casing and is linked to the latter by the flexible element forming a loop around the latter.

One embodiment, which applies to all kinds of watches, of a device for attaching a bracelet to a watch is made up of a flexible fastening element, two guides, two casing supports and a watch casing, in which:
The flexible element is a long object of small cross section, in particular a thread made of deformable plastic which can be joined up by welding, adhesive bonding, etc. or cut, depending on the embodiment.
The guides are tubes made of an essentially non-deformable material, protecting the bracelet and guiding the flexible element.
The supports are the intermediate elements between the bracelet and the watch casing, whose shape matches the shapes of the latter, and are made of a material that does not damage the surface of the casing.
In a variant, these supports are integral with the ends of the bracelet.
In another variant, the flexible element is fastened either to an attachment or at least to one casing support.

In one embodiment, the guides are inserted in the rings of the bracelet. To join the two ends of the bracelet, one end of the flexible element is passed through one guide and then the other. The two ends of the flexible element are then joined together by means suitable for the material of which the flexible element is composed (welding, adhesive bonding, etc.). The join is inserted in one of the guides and clamped in the corresponding ring of the bracelet, to guarantee a solid assembly. The ends of the bracelet are thus joined up by the two arms of the flexible element, which constitute not only the link between said ends but also the space into which the watch casing is inserted. The rings of the bracelet, containing the guides through which the flexible element passes, are inserted in the supports simply by pressing.

The watch casing may be of conventional shape or otherwise, and there is no limit on the material that can be used to make it. It comprises a rim on opposite sides of its circumference for receiving a flexible element. This groove or rim may extend around the entire periphery of the casing. The casing advantageously comprises a first lower rim and a second upper rim, in particular arranged symmetrically about a median axis, making the casing reversible. The upper and lower rims make it possible to fasten the casing by snap-fitting in the supports.

By moving the flexible element away, it is placed against the lower or upper rim of the casing, holding the casing in place.

The device that is the subject of the present invention makes it possible to move or change the watch without damaging the surface of the casing, because the flexible element, which fastens the watch to the bracelet or other attachment, is made in particular of a relatively nonextendable synthetic material such as nylon, or of metal.

The invention will be more clearly understood from the detailed description below which refers to the attached drawings, in which:

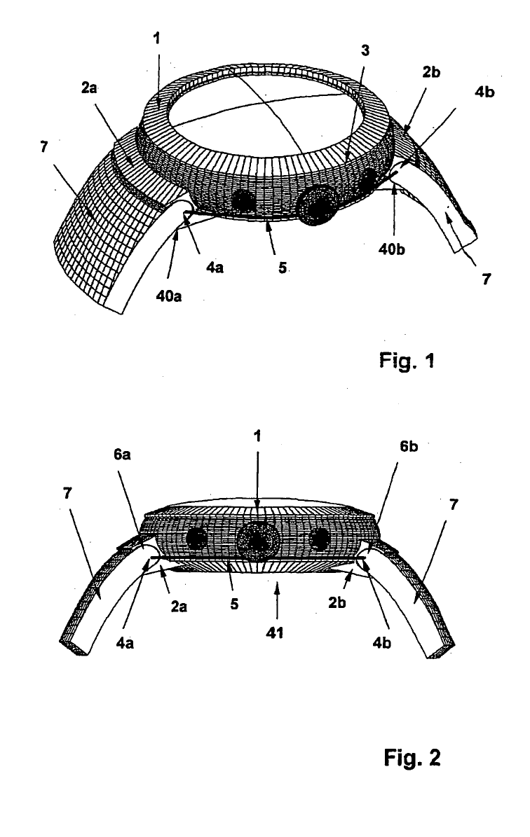

FIG. 1 shows, by way of example, a perspective view of a device for attaching a bracelet to a watch.

FIG. 2 shows a schematic section of this device for attaching a bracelet to a watch.

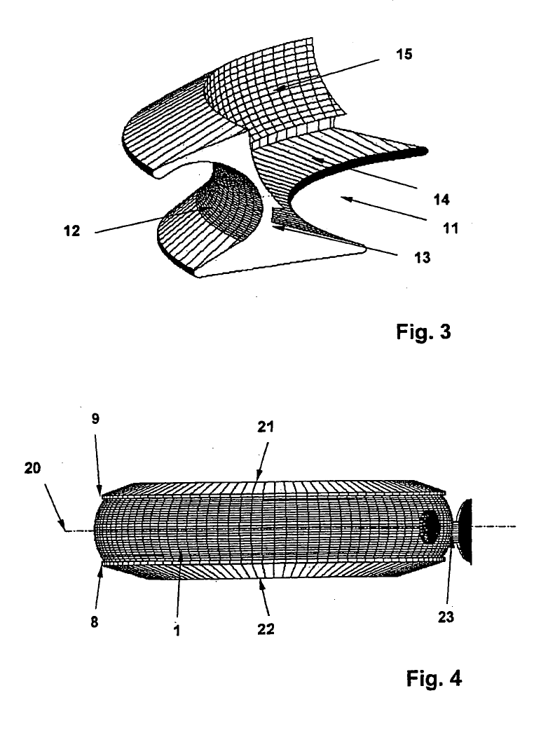

FIG. 3 shows a perspective view of a watch support.

FIG. 4 shows a side view of a reversible watch casing.

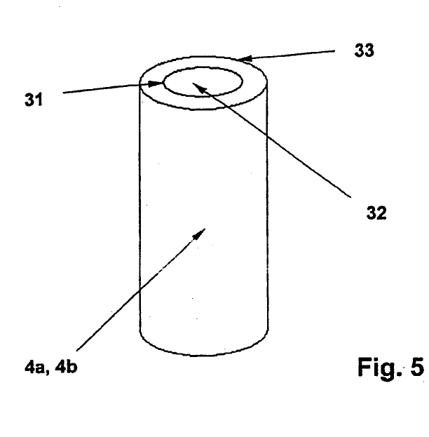

FIG. 5 shows a perspective view of a guide for a flexible element.

In one embodiment, a device for attaching a bracelet to a watch comprises:
a flexible fastening element (5—FIGS. 1+2), for joining two ends (40a, 40b—FIG. 1) of a bracelet or other attachment (7—FIGS. 1+2) by being inserted in the rings (6a, 6b—FIG. 2) of the bracelet (7);
two guides (4a, 4b—FIGS. 1+2), located inside the rings (6a, 6b) of the bracelet (7), for directing the flexible element (5) during assembly and preventing shearing of the rings (6a, 6b) of the bracelet (7);
a watch casing (1—FIGS. 1+2);
two supports (2a, 2b—FIGS. 1+2) that constitute the link between the casing (1) of the watch and the bracelet (7).

As a variant, the bracelet or other attachment (7) is integral with an internal profiled part that receives and supports the casing (1).

The flexible element (5), of circular cross section, is in particular a nylon thread and its length varies as a function of the pressure it is desired to exert on the casing (1). The flexible element (5) has two ends (not shown) that are joined together at the time of assembly.

The guides (4a, 4b) that prevent shearing of the rings (6a, 6b) of the bracelet (7), as seen above, are machined such that the inside diameter (31—FIG. 5) is greater than the outside diameter of the flexible element (5) and that the outside diameter (33—FIG. 5) is smaller than or equal to the inside diameter of the rings (6a, 6b) of the bracelet (7). Note that the guides (4a, 4b) are only essential if there is a risk of shearing of the material of the bracelet (7).

The casing supports (2a, 2b—FIGS. 1+2), which prevent the casing (1) from moving laterally and vertically, have an outer part (12—FIG. 3) of semicircular cross section for insertion of the rings (6a, 6b) of the bracelet (7), and an inner part (11—FIG. 3) composed of a base (14—FIG. 3) on which the casing (1) rests, a groove (13—FIG. 3) for fastening the casing (1) against the base (14) and a bearing surface (15—FIG. 3) serving as a guide for the insertion of the casing (1) in the supports (2a, 2b).

The flexible element (5) holds the bracelet (7) against the outer parts (12) of the supports (2a, 2b) and prevents the casing (1) from moving longitudinally.

The casing (1) of the watch has a rim (8—FIG. 4) around its lower circumference that is inserted in the groove (13) of the support (2) to fasten it against the base (14) of the support (2), and houses the flexible element (5) to prevent any accidental movement, as seen above.

As shown, the casing (1) advantageously comprises a first lower rim (8) and a second upper rim (9) arranged symmetrically about a median axis (20), making the casing reversible.

In one variant, the casing comprises only one, in particular central, rim.

The guides (4a, 4b) are inserted in the rings (6a, 6b) to prevent shearing of the bracelet (7) by the flexible element (5).

To join the two rings (6a, 6b) of the bracelet (7), one of the ends of the flexible element (5) is passed through one of the guides (4a, 4b), and then the other. The two ends of the flexible element (5) are then joined together by means suitable for the material of which the flexible element (5) is composed (welding, adhesive bonding, etc.). The join is inserted in one of the guides (4a, 4b) and clamped in one of the rings (6a, 6b) of the bracelet (7), to guarantee a solid assembly. The rings (6a, 6b) of the bracelet (7) are thus secured and the flexible element (5) thus delimits a space (41—FIG. 2) for insertion of the watch casing (1).

The rings (6a, 6b) of the bracelet (7), containing the guides (4a, 4b) through which the flexible element (5) passes, are inserted in the outer part (12) of the supports (2a, 2b) simply by pressing.

The casing (1), which advantageously comprises a lower rim (8) and an upper rim (9), is fastened by snap-fitting in the supports (2a, 2b). By moving the flexible element (5) away, said element is placed against the lower rim (8) or the upper rim (9) of the casing (1), depending on which side of the watch is selected by the wearer, holding said casing (1) in place.

The device for attaching a bracelet to a watch described is suitable for all kinds of shapes of bracelets and watches. It comprises at least one flexible element (5) forming a complete loop.

In short, the subject of the present invention is a watch comprising a casing (1), a bracelet (7) or other attachment and a device linking the assembly.

To join the two ends of the bracelet (7), one end of the flexible element (5) is passed through one of the guides (4a, 4b), and then the other. The two ends of the flexible element (5) are then joined together by means suitable for the material of which the flexible element (5) is composed (welding, adhesive bonding, etc.). The join is then inserted in one of the guides (4a, 4b) and clamped in the corresponding ring of the bracelet (7), to guarantee a solid assembly. The ends of the bracelet (7) are thus joined up by the two sides of the flexible element (5), which constitute not only the link between said ends but also determine the space (41) for insertion of the watch casing (1).

The rings (6a, 6b) of the bracelet (7), containing the guides (4a, 4b) through which the flexible element (5) passes, are inserted in the outer part (12) of the supports (2a, 2b) simply by pressing.

The casing (1) is fastened by snap-fitting in the supports (2a, 2b), and by moving the two sides of the flexible element (5) away and placing them in the lower groove (8) of the casing (1), the latter is positioned.

In a variant, use is made of an attachment consisting of a body that bears against only one side of the watch casing, and a flexible element (5) that forms a loop designed to link said watch casing (1) to the attachment. This body may for example be a clip for fastening the watch to clothing or the like. It may advantageously comprise an internal profiled part that serves as a support for the casing (1), or may cooperate with a support that is inserted between the casing (1) and the attachment (7), such as the supports (2a, 2b) described.

1. A watch comprising a casing (1), at least one attachment (7) such as a bracelet and a device linking the casing-attachment assembly, characterized in that the attachment (7) is linked to the casing (1) by means of at least one long flexible element (5) designed to hold the attachment (7). against the casing (1), the long flexible element (5) delimiting in particular a space in which the casing (1) may be inserted and held in place by contact of the flexible element (5) on its circumference.

2. The watch as claimed in claim 1, characterized in that the attachment is a bracelet (7) whose two ends (40a, 40b) are linked to the casing (1) by means of the flexible element (5).

3. The watch as claimed in claim 1 or 2, characterized in that it comprises at least one casing support (2a, 2b), which is inserted between the attachment and the casing (1), and in that the flexible element (5) is fastened either to the attachment (7) or at least to one casing support (2a, 2b).

4. The watch as claimed in claim 2, characterized in that the casing supports (2a, 2b) have an outer part (12) for insertion of the rings (6a, 6b) of the bracelet (7), and an inner part (11) on which the casing (1) rests.

5. The watch as claimed in claim 1, characterized in that the attachment (7) is integral with an internal profiled part that receives and supports the casing (1).

6. The watch as claimed in one of the preceding claims, characterized in that the casing (1) has a rim (8) around its circumference that is inserted in a groove (13) of a support (2) which is integral with the attachment (7) or otherwise.

7. The watch as claimed in claim 6, characterized in that the casing (1) has a first rim (8) around its lower circumference and a second rim (9) around its upper circumference, making the watch reversible.

8. The watch as claimed in one of the preceding claims, characterized in that the flexible element (5) consists of a thread made of plastic.

9. The watch as claimed in one of claims 1 to 7, characterized in that the flexible element (5) consists of a metal thread.

10. The watch as claimed in one of the preceding claims, characterized in that the ends of the flexible element (5) are fastened in at least one guide (4a, 4b) inserted in the attachment (7) or in a casing support (2a, 2b) integral with the attachment (7).

11. The watch as claimed in one of the preceding claims, characterized in that at least one flexible element (5) forms a complete loop.

12. The watch as claimed in claims 10 and 11, characterized in that it comprises two flexible elements (5) secured in at least one guide (2a, 2b) to form a complete loop.

13. The watch as claimed in claim 11, characterized in that the attachment (7) consists of a body that bears against the casing (1) and is attached thereto by the loop formed by the flexible element (5).

14. An assembly of two parts of a bracelet (7) of a watch as claimed in claim 1, characterized in that the ends of the bracelet (7) are linked by means of at least one long flexible element (5) that delimits a space in which a casing (1) may be inserted and held in place by contact of the flexible element(s) on its circumference.

15. A watch casing as claimed in one of claims 1 to 13, characterized in that the casing (1) comprises a rim (8) on opposite sides of its circumference for receiving said flexible element (5).

16. The watch casing as claimed in claim 15, characterized in that it comprises a first lower rim (8) and a second upper rim (9), in particular arranged symmetrically about a median axis (20), making the casing reversible.

17. The watch casing as claimed in claim 16, characterized in that each rim (8, 9) extends around the entire circumference of the casing.

18. A watch attachment as claimed in claim 13, characterized in that it consists of a body that bears against the casing (1), and a flexible element (5) that forms a loop designed to link a watch casing (1) to the attachment (7).

19. The watch attachment as claimed in claim 18, characterized in that the flexible element (5) is secured to the attachment (7).
